(19) United States
(12) Patent Application Publication
(10) Pub. No.: US 2002/0057801 A1
(43) Pub. Date: May 16, 2002

(54) Method for secure data transmission in selling products

(75) Inventors: Herbert Blum, Minden (DE); Detlef Tenhagen, Rodinghausen (DE)

Correspondence Address: Norman P. Soloway, HAYES, SOLOWAY, HENNESSEY, GROSSMAN & HAGE, P.C., 130 W. Cushing Street, Tucson, AZ, 85701, US

(73) Assignee: Harting Vending GmbH & Co. KG

(21) Appl. No.: 09/921,402

(22) Filed: Sep. 24, 2001

(30) Foreign Application Priority Data
Aug. 4, 2000 (DE) 10038226.6

(51) Int. Cl. H04K 1/00

(52) U.S. Cl. 380/258; 705/65

(57) ABSTRACT

A method is proposed for transmitting product-specific data in a manner protected against imitation by means of one or more information carriers for the process of purchasing products, whereby in the process the selection of the products and the delivery thereof is realized in spatially separated zones. The information carriers are provided as a (paper) document, a transponder, a chip or a chip card (smart card), wherein self-checking encryption codes which are independent from each other and which are provided on each of said information carriers ensure a correct product delivery.

The invention relates to a method for secure data transmission in selling products in which a product selection terminal as well as a counter means having a document reading station, and a product delivery storage are provided and in which a product is selected at the product selection terminal and a document for the selected product is output by means of a printer device.

In purchasing products and especially products with higher quality, the selection and the delivery of the products being handled in different spatial zones, a counterfeit-proof transmission of the product data is required starting at the detection thereof up to the authorized product delivery.

From DE 42 17 045 A1 a method for selling products is known in which the products are stored in an automatic delivery apparatus and in which at least one product delivery terminal as well as a counter are provided. In selecting the products at the product selection terminal a signal specific for the selection is generated. After the payment of the product value the counter generates a purchase document which is supplied to a reading device of the automatic delivery apparatus and which causes the delivery of the corresponding product from the automatic delivery apparatus.

Further, from DE 695 04 729 T2 which is a translation of EP 0 670 132 B1 an apparatus for providing packs of cigarettes at a plurality of cash desks is known wherein the apparatus comprises a central store room as well as a means set up on the cash desk and capable of performing a selection of the kind of packs, and a transport system for supplying the packs to the cash desk

In the known methods it is disadvantageous that either expensive transport systems have to be provided or the purchase documents present an insufficient security against improper use especially for products of higher quality.

It is therefore an object of the invention to provide a method of the kind mentioned in the introduction, such that one or more documents and information carriers for product identification, respectively, are provided with measures protected against copying and ensuring an authorized product delivery.

This object is achieved by the fact that said document is provided with a first self-checking encryption code and with a first algorithm for encrypting a product identification of the selected product or the selling identification of a selling process, wherein one or more selling identifications are provided on said document, that said encryption on said document is identified (decrypted) at the document reading station, wherein the value associated to said product is detected and forwarded to said counter means for balancing the value (payment), that after the payment of said product said counter means delivers an electronic information carrier by means of an output device connected thereto, wherein said electronic information carrier includes a CPU generating a second self-checking encryption code having any encryption depth by means of a second algorithm for encrypting all the products being paid, wherein said second encryption code is different from or even the same as the first encryption code, and that said electronic information carrier is supplied to a reading unit in said product delivery storage in order to identify and to decrypt said second encryption code, wherein in case of an authorized identification the delivery of the selected product in the selected quantity from the product delivery storage is started.

Advantageous developments of the invention are indicated in the claims 2-5.

The advantages achieved by the invention in particular consist in that a product sale is preferably performed with at least two information carriers which are independent with respect to their storage form so that a secure authorized product delivery is ensured.

In this case the desired product is advantageously selected by a customer at an electronic product delivery terminal arranged within a product offering zone. By means of a printing device associated to the product selection terminal a document serving as an information carrier is output representing the selected product in plain writing for the customer and at the same time comprising a coded and self-checking encryption which at the best is to be decoded by a document reader.

After the payment of the product in a counter zone an electronic information carrier is output to the customer by means of an output device arranged in the immediate vicinity of the counter.

This information carrier may advantageously be embodied as a transponder, as a coin-like chip or as a chip card, which is also called smart card. In one case, the information carrier advantageously includes a computing device (CPU) which automatically generates a self-checking encryption encoded by an algorithm.

In another case, the delivery means includes a computing device (CPU) generating the encryption code which is then stored in an information carrier arranged as a passive memory which possibly is protected against undesired reading by means of a multi-digit PIN.

The information carrier together with the encrypted product data is supplied to a reading unit contained in a product delivery storage arranged outside of the product offering zone in order to be decoded, wherein after a plausibility check by means of the corresponding algorithm f₂, f′₂, the decryption arranges for the delivery of the selected product from a product delivery storage.

The information carrier at first advantageously remains in the product delivery storage and, after its recirculation to the counter zone, may be provided at any time with a new encryption.

Further, the product delivery from the product delivery storage is advantageous in that when additional security checks are required, for example, if alcohol or cigarettes are delivered according to the regulations for the legal protection for children and young persons, the inhibition of the product delivery may be performed by an authorized supervisor.

As a result, for example, an identity check may be shifted from the counter staff to the security staff.

Further, since the product is coded an authorization check may already be included in the operation of selection at the product selection terminal.

Advantageously, the method especially applies for counter zones in which the customer already can perform himself the identification of the product for the payment operation.

Further, a coded data transmission by means of a wireless or a wired data transmission may advantageously be employed between the product delivery storage and the product selection terminal, in order to protect it against an external data manipulation (hacker attack).

An embodiment of the invention is shown in the drawing and is further explained below. In the drawing:

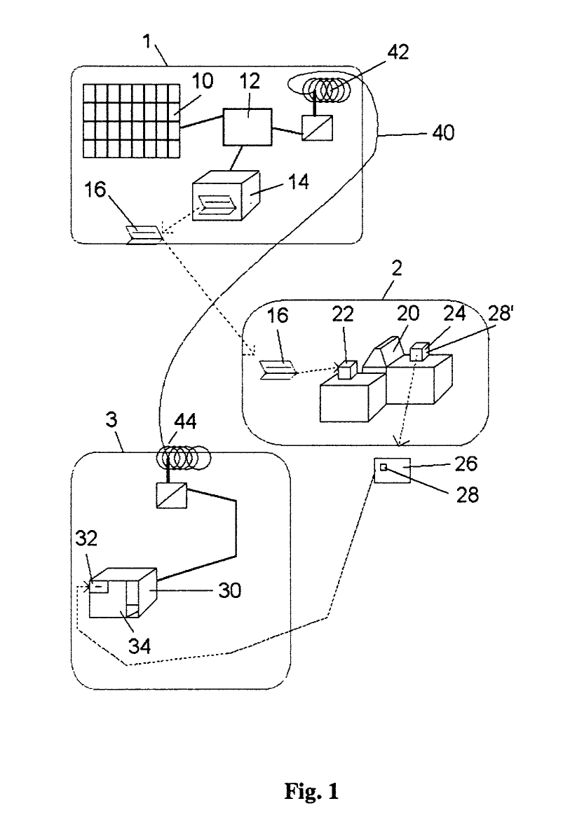

FIG. 1 shows a diagrammatic view of the method for secure data transmission in selling products; and

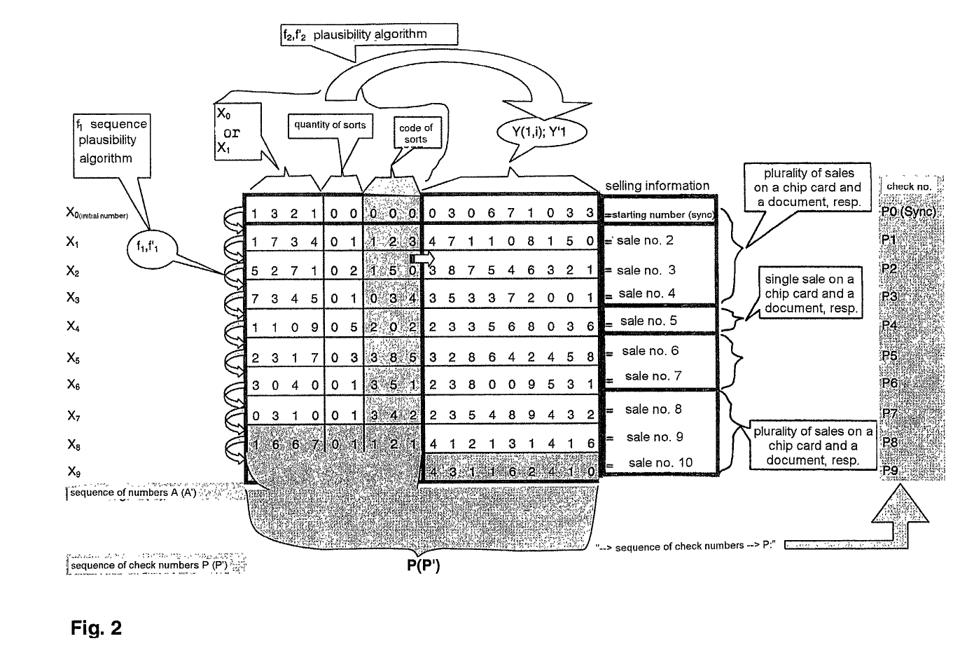

FIG. 2 shows an explanation of the encryption method.

In FIG. 1 the method for secure data transmission in selling products is shown in a diagrammatic view.

Here, the whole selling zone is divided into three zones: a product offering zone 1, a counter zone 2 and a product delivery zone 3.

Various products are selected by means of a product selection terminal 10 which is arranged spatially within the product offering zone 1, whereby a document printer 14 connected to the product selection terminal outputs a document 16.

The product selection terminal is data-technically connected to one or more product delivery storages 30 arranged in the product delivery zone 2.

The document 16 serving as an information carrier contains the selected product in plain writing as well as a code related at least to the sort and the quantity of the product. The code is possibly formed by a random number and by a self-checking number P and an algorithm f₁, respectively, and is generated and output by a computing device CPU 12 provided at the product selection terminal 10.

In this case, the product identification and also the sale identification of a selling operation may be used for encoding.

At the best the document may be output in paper form and is identified and withheld by a document reader 22 contained in the counter means 20 when the product offering zone 1 is left.

After balancing this product, or even after balancing further products not ordered by means of the product selection terminal, by cash payment or cashless payment a delivery means 24 arranged in the counter zone 2 outputs a further information carrier 26 which, however, contains its own CPU 28 automatically performing an encryption of the paid products by means of a self-checking number P′ and an algorithm f′₁, f′₂.

The information carrier 26 may be embodied as a transponder, as a single chip or as a chip card (smart card).

In a variation, however, also the delivery unit 24 may contain a CPU 28′ performing an encryption and transmitting this encryption to an information carrier 26′ arranged as a passive memory.

Additionally, the encryption may possibly be provided with a multi-digit PIN.

In the product delivery zone 3, the information carrier 26, 26′ is supplied to a reading unit 32 of the product delivery storage 30 decoding the encrypted information and initiating the delivery of the selected products 40.

The information carriers remain in the product delivery storage until they are used again.

In this example a method is described in which at least two independent encryption methods are used, however, this is not absolutely necessary, since each encryption method may also be employed individually.

Explanations with respect to the method for processing and validating the self-checking data with the help of a self-checking number Pᵢ containing information about the purchase and the authorization with respect to the sort and the quantity of the selected product in view of the delivery at the delivery means 30 and the possibility of coding a logical sequence in a determined portion of the contained digits.

Method:

In the encryption process aiming at the self-checking and the authorization-checking of the operator (final customer) the method concerns the one computation rule (algorithm f₂) which transfers the number X₁ consisting of m digits into the number Y₁ which at the best, but not necessarily, also consists of m digits.

This encryption as well as the checking method may by performed at the product selection terminal for establishing the document by means of a self-checking number P, and at the delivery apparatus in the counter zone with the information carrier 28 embodied as a chip card by means of the self-checking number P′.

It is not relevant whether in these cases the algorithms are each the same (f₁ and f₂) or are different (f′₁ and f′₂, with f₁≠f₁ and f′₂, with f′₂≠f₂). For the self-checking operation a discrimination between these two algorithms is not absolutely necessary so that they might be the same.

In the spelling shown in FIG. 2 the two sets of digits of the number X₁ and the number Y₁, respectively, together compose the desired self-checking encryption number P₁ (and P′₁, respectively).

The encryption algorithm f (i.e. f₁, f₂, f′₁, f′₂) may actually be anyone. In particular, each known encryption algorithm, for example DES(-RSA), Rijndael, Elliptic Curves or the like or even each newly developed encryption algorithm or the like is possible in this case as far as it is unambiguous with respect to the number Y₁ computed from the number X₁ applied to the input and thus, if it composes the desired self-checking encryption number P₁, for example, by “composing” the digits in the order “XY” or possibly if it converts the composition to the desired number by a further computation. Then X possibly contains the high-order digits and Y contains the low-order digits of the number P, however, also the inverted order (X=low-order digits/Y=high-order digits) is conceivable. The number of digits m has to be selected sufficiently high with respect to the base of the figures.

At the best 20 digits may be provided, however, also more or less digits may be provided within the scope of the encryption depth when using figures as well as alphanumeric characters (A-Z; a-z) as well as special characters. Here, “may be provided” in the sense of the information technology means the number of the used “bits per character” of the used digit, which is in particular used to ensure sufficient security against “lucky shots”. Thus, the term “number” is merely a “wild card symbol” for each applicable information unit in the mathematical sense.

Plausibility check algorithm f₁ between the generated sale information units in the sense of the “continued sequence” plausibility (“Fortfolge”-Plausibilität):

Further, a second encryption function f₂ is generated which is independent from the first with respect to the algorithm (or possibly even identical) and which exclusively generates a subsequent number X₂ from an input number X₁ in the same unambiguous way. Moreover, a number X₃ may be formed from the number X₂ in the same unambiguous way. The sequence A of numbers which is produced thereby as a biunique and reproducible sequence A serving with each of its individual values as an argument Xᵢ of the subsequent function f₂ in order to generate the above-desired number Pᵢ.

Then, only a part of the used digits within this number Xᵢ may or must be used for the plausibility check with respect to the number X₍ᵢ₋₁₎ with the help of the algorithm f₁.

The purpose of this plausibility check results from the consideration of a conceivable fraud procedure in which a final customer might try with a fraudulent intention to copy the information carrier in which is written by the CPU 28 which is technologically not impossible even though very difficult, in order to obtain at the product delivery unit in an unsupervised manner products in a number corresponding to the quantity of the products and thus to the reproduced information carrier units resulting from the copying operation, after leaving the counter and the preceding payment of a single information carrier unit at the counter.

The uniqueness of the information relevant for the sale contained in the CPU 28 within the scope of the continued sequence of the secret algorithm f₁, f₂ is thus an essential component of this method and cannot be separated therefrom.

The reproducibility of the continued sequence A generated by the secret algorithm f₁ at the relevant digits is thus also a relevant component of the method and cannot be separated therefrom.

Possibilities of storing information within the number X:

A further part of the digits of the corresponding number Xᵢ may or must be used to receive the information about the selected sort and the selected quantity of this sort, and possibly to receive additional information such as the legal protection for children and young persons, however, without the necessity of including these further digits in the plausibility check with respect to the used algorithms f₁ and f′₁.

In this case, it is not necessary, even though not unconceivable and thus also applicable, that the information which is not relevant for the performance and checking operation by the algorithm f₁ (f′₁) is encrypted again. However, this information may be represented in plain writing as indicated in the example.

Further, there is no absolute instruction concerning the ratio of the number of digits of the information within the number X in proportion to the number of digits of the information of the plausibility check done by the algorithm f₁ (f′₁) for the correct sequence of the numbers Xᵢ, so that this ratio may be anyone in so far as a sufficiently secure use of the plausibility check by the algorithm f₁ (f′₁) remains possible.

It is also conceivable that this method may by applied to fixed quantities and fixed codes of sorts; then, there is no necessity to transmit quantities or codes or any other information, since merely a single product in the number one is to be sold. In this special case even all digits of the number X may completely be used for the plausibility check with respect to the algorithm f₁ (f′₁).

Schemata:

The continued application of this schema leads to the sequence P of check numbers. This schema may universally be described by means of the functions f₁ and f₂ (thus, also by means of f₁, f₂):

specially: Y₁=f₂(X₁)/generally: Yₙ=f₂(Xₙ):→P₁=P₁={“X₁Y₁”}

specially: Y₂=f₁(X₁)/generally: X₍ₙ₋₁₎=f₂(Xₙ):→Xᵢ

each as an argument for f(x).

As a “starting number” (initial number) for this scheme may, but does not absolutely have to, exist a number X₀ intentionally selected by the user which, as far it is desired, offers a possibility to ensure the reproducibility of the sequence A of numbers by means of the respective algorithm f in CPU 12 and CPU 28, respectively. Alternatively a random number generated by computer might be used a knowledge about which neither the user nor a service man nor any human being in general would have to have.

When the “starting number” is the same in the generating CPU 12 and in the second checking CPU 28 and in each further CPU, then a simple further security function within the scope of a “plausibility check” may be realized:

The same starting numbers lead to the same sequences A of numbers if the algorithms are the same, and thus to the same sequence P of check numbers within the scope of the above-mentioned relevant digits of the sequence A(Xᵢ) of numbers, but it is understood that it is exclusively related to the relevant digits used for the plausibility check of the continued sequence according to the algorithm f₁ (f₁).

As a particularly advantageous embodiment of the invention results the universal possibility to code information with respect to selected quantities and selected sorts of products within the numbers Pᵢ as well as to check the consistency of continued sequences of numbers in order to inhibit fraud and improper use by the customer with respect to the repeated use of already used sequences of numbers, provided that the initial number (“starting number”) in all CPU instances within the sequence A of numbers is the same.

On condition that the initial number is the same in all CPU's each uniquely generated document and information carrier, respectively, which is generated in the CPU 12 as well as in the information carrier CPU 28, may be generated and also used only one time in this form for selling.

### Table of Reference Numbers

| | |
|---|---|
| 1 | product selection zone |
| 2 | counter zone |
| 3 | product delivery zone |
| 10 | product selection terminal |
| 12 | CPU |
| 14 | document printer |
| 16 | document |
| 20 | counter means |
| 22 | document reader |
| 24 | output device |
| 26 | information carrier |
| 28, 28′ | CPU |
| 30 | product delivery storage |
| 32 | reading unit |
| 34 | products |
| 40 | data transmission path |
| 42 | I/O product selection terminal |
| 44 | I/O product delivery storage |

1. A method for secure data transmission in selling products, wherein a product selection terminal (10) as well as counter means (20) comprising a document reading station (22), and a product delivery storage (30) are provided, and wherein at the product selection terminal (10) a product is selected and a document (16) for the selected product is output by means of a printing device (14), characterized in
that said document (16) is provided with a first self-checking encryption code (P) and with a first algorithm (f₁, f₂) for encrypting a product identification of the selected product or the selling identification of a selling process, wherein one or more selling identifications are provided on said document,
that said encryption on said document (16) is identified (decrypted) at the document reading station (22), wherein the value associated to said product is detected and forwarded to said counter means (20) for balancing the value (payment),
that after the payment of said product said counter means (20) delivers an electronic information carrier (26) by means of an output device (24) connected thereto, wherein said electronic information carrier includes a CPU (28) generating a second self-checking encryption code (P′) having any encryption depth by means of a second algorithm (f₁, f′₂) for encrypting all the products being paid, wherein said second encryption code is different from or even the same as the first encryption code, and
that said electronic information carrier (26) is supplied to a reading unit (32) in said product delivery storage (30) in order to identify and to decrypt said second encryption code (P′), wherein in case of an authorized identification the delivery of the selected product (34) in the selected quantity from the product delivery storage (30) is started.

2. The method for secure data transmission in selling products according to claim 1, characterized in that said output device (24) includes a CPU (28′) generating said second self-checking encryption code (P′) by means of a second or the same algorithm (f₁, f₂, f′₁, f′₂) for encrypting the products being paid, wherein said electronic information carrier (26′) is provided as a passive memory and wherein a PIN is additionally inserted.

3. The method for secure data transmission in selling products according to claim 1 or 2, characterized in that in a variation said first algorithm (f₁, f₂) does not represent an encryption algorithm and thus no encryption of said document (16) is applied.

4. The method for secure data transmission in selling products according to any of the preceding claims, characterized in that an encrypted data transmission between said product delivery (30) and said product delivery terminal (10) is provided.

5. The method for secure data transmission in selling products according to any of the preceding claims, charaterized in that said data transmission between the individual zones comprising the product selection zone (1), the counter zone (2) and the product delivery zone (3) is established by means of information cArriers and/or devices operating by means of printing engineering radio engineering, lighting engineering or magnetically.
